(19) United States
(12) Patent Application Publication
(10) Pub. No.: US 2006/0125625 A1
(43) Pub. Date: Jun. 15, 2006

(54) Modular measuring transducer provided with a galvanically separated sensor

(75) Inventors: Detlev Wittmer, Maulbronn (DE); Wolfgang Babel, Weil der Stadt (DE)

Correspondence Address: BACON & THOMAS, PLLC, 625 SLATERS LANE, FOURTH FLOOR, ALEXANDRIA, VA, 22314, US

(73) Assignee: Endress + Hauser Conducta GmbH + Co. KG, Gerlingen (DE)

(21) Appl. No.: 10/536,326

(22) PCT Filed: Nov. 26, 2003
(86) PCT No.: PCT/EP03/13272

§ 371 Date: Nov. 30, 2005

(30) Foreign Application Priority Data
Nov. 28, 2002 (DE) 102 55 741.1

(51) Int. Cl. G08B 1/00

(52) U.S. Cl. 340/531; 345/531

(57) ABSTRACT

The inventive modular measuring transducer is used for galvanic separation of the modules of said transducer and for avoiding the use of data transmission channels and comprises a sensor module for detecting a measured value, and an electronic module. Said sensor module and electronic module are connected to each other by means of a contactless interface, thereby making it possible to power the sensor module, and to carry out the data exchange between the sensor module and the electronic module. In addition, said electronic module comprises a receiver-transmitter for wireless data interchange with an additional transmitting or receiving-transmitting station.

The present invention relates to a modular measuring transducer, which includes a sensor module, and an electronics module coupled with the sensor module, with the sensor module being coupled to the electronics module via a contactless interface, by way of which the power supply of the sensor module, and the data exchange between the sensor module and the electronics module, are accomplished. The interface can be constructed in the manner described in European patent application EP 1 206 012 A2, wherein especially inductive interfaces appear suitable.

Although the interface in the named European patent application, disclosed as a plug connection, assures galvanic decoupling between the sensor module and the electronics module, the solution described there still requires the data to be transferred between the electronics module and a superordinated unit, for example a control room, via a cable.

In particular applications, this is disadvantageous, because the modular measuring transducer is difficult to access or is very far removed from the superordinated unit. In addition, the danger exists that the data exchange between the superordinated unit and the measurement transducer is impaired through damaging of the cable. Furthermore, it can be disadvantageous when the measurement transducer is galvanically coupled to the superordinated unit, especially when local fluctuations in potential can occur.

On the other hand, German patent disclosure DE 13 703 854 discloses a modular measuring transducer, in which a measuring sensor is installed in a measuring head via a screw-connection, with the measuring head having a sending- and receiving-unit in order to communicate wirelessly with a central data collection unit. However, the measuring sensors, for example pH-electrodes, are not galvanically separated from the measuring head. Rather, a conventional, metallic contact between the measuring head and the measuring sensors is understood.

This is disadvantageous in that, during exchange of measuring sensors, a danger of explosion exists in vulnerable areas as a result of spark discharge. In addition, the contacts between the measuring sensor and the measuring head can corrode such that the signal transfer is impaired.

An object of the present invention is, therefore, to provide, for a modular measuring transducer, an electronics module, which overcomes the described disadvantages of the state of the art.

This object is achieved, in accordance with the invention, by the electronics module as defined in independent claim 1, as well as by the modular measuring transducer as defined in independent claim 5.

The modular measuring transducer of the invention includes a sensor module for registering a measured variable, and the electronics module of the invention, with the sensor module and the electronics module being coupled with one another via a contactless interface, by way of which the power supply of the sensor module and data exchange between the sensor module and the electronics module are accomplished, with the electronics module having additionally a sending-, or sending- and receiving, unit for wireless data exchange with a complementary receiving-, or receiving- and sending, station.

The power supply of the electronics module can be accomplished either via a supply cable, or self-sufficiently, that is, e.g. through solar cells, by means of a battery, or by means of a fuel cell. Naturally, the different forms of power supply can be combined with one another.

The wireless data exchange between the electronics module and the complementary receiving-, or sending- and receiving, unit can be accomplished, for example, by means of radio, ultrasound, or light, especially infrared light. The chosen type of data transfer depends on the particular conditions of the area of use. For use in laboratory operations with short ranges, especially a data transfer by means of infrared light appears suitable, whereas for systems with greater ranges, radio transmission is preferred. For certain applications, data transfer via a mobile radio network, or via satellite, is also suitable.

The invention can generally be implemented with any sensors, especially with potentiometric sensors, turbidity sensors, gas sensors, pressure sensors, fill level sensors, flow rate sensors, spectroscopic sensors, photometric sensors, temperature sensors, and humidity sensors.

Further advantages and aspects of the present invention will be evident from the dependent claims and the description of an example of an embodiment in the drawing, the figures of which show as follows:

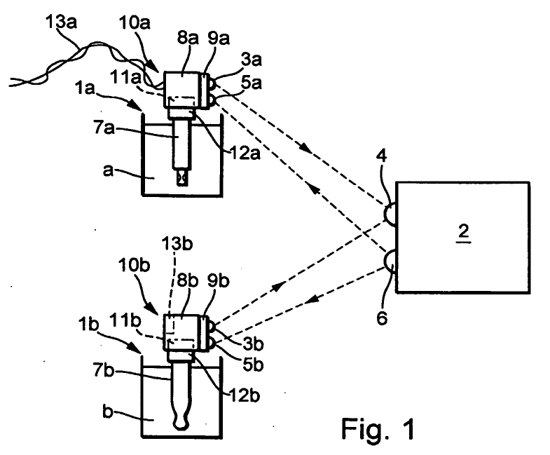

FIG. 1 a measuring arrangement with a measuring transducer in accordance with the present invention.

The measuring arrangement shown in FIG. 1 includes two modular measuring transducers, namely a modular turbidity measurer 1a, and a modular pH transmitter 1b. The two modular measuring transducers 1a, 1b exchange data with a base station 2. The modular turbidity measurer 1a includes an electronics module 10a, which includes a circuit 8a for processing a sensor signal received from a sensor module 7a. If necessary, the circuit 8a can additionally include means for reading out device parameters of the electronics module 10a, and of the sensor module 7a. Furthermore, the electronics module 10a includes a transfer unit 9a for sending data to, and receiving data from, the base station 2. In the case of this example of an embodiment, the data transfer unit includes an infrared sender 3a, and an infrared receiver 5a, with the base station 2 having a complementary receiver 4, and sender 6, respectively. The data exchange can be accomplished, for example, according to the IrDA standard.

The power supply of the electronics module 10a is accomplished via a supply line 13a. In a first form of embodiment, the supply line 13a serves exclusively for supplying power, whereas in a further form of embodiment, the supply line is, at the same time, used for data transfer, e.g. by regulation of the supply current (4_{—}20 mA), or according to the HART standard.

For the power supply of the sensor module, and for the data exchange between the sensor module 7a and the electronics module 10a, a contactless plug connection is provided, which includes a receptacle 11a, provided on the underside of the sensor module 10a, and a plug 12a, which is connected with sensor module 7a, and fits into the receptacle 11a. The plug connection is preferably detachable. Naturally, the plug connection can also be reversely constructed, that is, a plug can extend from the underside of the electronics module, and the sensor module has a plug-in head for receiving the plug.

Presently preferred are plug connections with an inductive transfer of data and power, or energy. To this end, for example, a first cylindrical coil can be arranged in the shell of the receptacle 11a, with the plug 12a having a second cylindrical coil, which is arranged coaxially with the first cylindrical coil. In an alternative embodiment, the plug 12a and the receptacle 11b have, in each case, a coil with a toroidal core half, with the end surfaces of the toroidal core halves being in alignment with one another and positioned in close separation to one another, when the plug is arranged in the receptacle.

The inductive power, or energy, transfer from the electronics module to the sensor module is accomplished via an AC signal, which is supplied from the electronics module. For the data exchange between the sensor module and the electronics module, preferably the amplitude of the AC signal is modulated (ASK: Amplitude Shift Keying); however, other modulation types are also possible, such as pulse width and frequency modulation. The transfer of data to the sensor module is accomplished here through direct modulation of the supplied AC signal, with a load modulation occurring for the data transfer from the sensor module to the electronics module.

Further details and alternatives concerning the configuration of the inductive plug connection, and the transfer of data and power, are described in the patent application EP 1 206 012 A2. Details regarding a possible construction of a sensor module with a contactless plug are disclosed in the German patent application with the file number 10218606, also pending.

FIG. 1 additionally shows a modular measuring transducer 1b, which is constructed as a pH-transmitter. It has essentially the same structure as the modular turbidity measurer 1a, such that, in the following, only the differences as compared to the previously described turbidity measurer will be discussed.

The sensor module 7b includes, for the pH-transmitter, a pH-electrode, which is connected with the electronics module 10b by means of the plug-in head 12b in the receptacle 11b of the contactless plug connection.

The power supply of the modular measuring transducer 1b is accomplished decentrally, for which purpose a battery 13b is provided in the housing of the electronics module 10b. In a further preferred embodiment, the local power supply is accomplished using a fuel cell, or a solar cell. The assignment of the power supply types to the different sensor types shown is only for the purpose of illustration, and implies no imperative technical correlation.

1-5. (canceled)

6. An electronics module for a modular measuring transducer having:
a sensor module and a circuit connected to said sensor module, wherein:
said sensor module and said circuit are connected together via a contactless interface, by way of which power supply of said sensor module and data exchange between said sensor module and said circuit are accomplished;
said circuit includes a sending-, or sending- and receiving, unit for wireless data exchange with a complementary receiving-, or receiving- and sending, station.

7. The electronics module, as claimed in claim 6, further having:
a connection for a supply line for supplying power to said circuit.

8. The electronics module, as claimed in claim 6, wherein:
the power is supplied by one of: solar cell, a battery, and a fuel cell.

9. The electronics module, as claimed in claim 6, wherein:
said wireless data exchange between said circuit and said complementary receiving-, or sending- and receiving, unit, is accomplished by one of: radio, ultrasound, and light, especially infrared light.

10. A modular measuring transducer, comprising:
an electronics module, as claimed in claim 6, for registering a process variable.
